(19) United States
(12) Patent Application Publication
(10) Pub. No.: US 2018/0184627 A1
(43) Pub. Date: Jul. 5, 2018

(54) Amphibian Environment Filtration and Purification Climbing Platform

(71) Applicant: Yiwei Liang, Zhongshan City (CN)

(72) Inventor: Yiwei Liang, Zhongshan City (CN)

(21) Appl. No.: 15/393,601

(22) Filed: Dec. 29, 2016

(51) Int. Cl. A01K 63/04; B01D 35/26; B01D 35/02; C02F 1/28; A01K 63/00; A01K 63/06; A01K 61/00

(52) U.S. Cl. CPC A01K 63/045; B01D 35/26; B01D 35/02; C02F 2103/20; A01K 63/006; A01K 63/06; A01K 61/00; C02F 1/283

(57) ABSTRACT

An amphibian environment filtration and purification climbing platform which includes an amphibious climbing platform system is disclosed. The amphibious climbing platform system includes a climbing platform holder and an oblique climbing platform. The oblique climbing platform includes a horizontal dwelling segment which is horizontally arranged for amphibians to dwell on and an oblique crawling segment which is obliquely arranged for the amphibians to crawl to the horizontal dwelling segment from water. The horizontal dwelling segment is located at the upper water surface end, and the oblique crawling segment is located at the lower water surface end. According to the amphibian environment filtration and purification climbing platform of the invention, ecological breeding environments of amphibians and reptiles are improved, methods of breeding the amphibians are optimized, life habit features of the amphibians are preferably satisfied, and health conditions of the amphibians and reptiles bred are increased.

### TECHNICAL FIELD

The present invention relates to the technical field of amphibian breeding facilities, and more particularly, to an amphibian environment filtration and purification climbing platform.

### BACKGROUND

With the development of cultural diversity in the modern society, more and more consumers began to breed amphibians and reptiles as pets, thus resulting in an increasingly larger market of amphibian and reptile pets. A purification and filtration climbing platform adaptive to amphibian breeding environments has not been disclosed in the market or literatures like published trade journals yet. Moreover, conventional filtering equipment for breeding aquatic pets implements water quality optimization using an ordinary water circulation manner, which cannot satisfy the life habit features of amphibians preferably, so that the amphibians have to be under a diving condition for a long term, and the quality of the water for breeding the amphibians is deteriorated quickly; therefore, the amphibians cannot dwell on a clean and dry land sufficiently; in this way, the amphibians bred are under unhealthy conditions frequently. In view of the foregoing defects of the prior art, it is necessary to provide an integrated filtration climbing platform which has a water quality environment purification function, and also integrates the long-term diving and on-land resting functions for amphibians.

### SUMMARY

In order to overcome the defects of the prior art, the present invention provides an amphibian environment filtration and purification climbing platform which has a water quality environment purification function, and also integrates the long-term diving and on-land resting functions for amphibians, and can satisfy the life habit features of the amphibians.

To solve the technical problems, the present invention employs a technical solution as follows:

An amphibian environment filtration and purification climbing platform includes an amphibious climbing platform system, wherein the amphibious climbing platform system includes a climbing platform holder and an oblique climbing platform, the oblique climbing platform includes an upper water surface end and a lower water surface end, and the upper water surface end is fixedly connected with the climbing platform holder.

As a further improvement of the foregoing technical solution, the oblique climbing platform includes a horizontal dwelling segment which is horizontally arranged for amphibians to dwell on and an oblique crawling segment which is obliquely arranged for the amphibians to crawl to the horizontal dwelling segment from water; moreover, the horizontal dwelling segment is located at the upper water surface end, and the oblique crawling segment is located at the lower water surface end.

As a further improvement of the foregoing technical solution, a plurality of hollow drain holes are arranged in the oblique climbing platform.

As a further improvement of the foregoing technical solution, a cyclic purification system is further included, wherein the cyclic purification system includes a filter tank, a filter pump and a filter core groove arranged in the filter tank; the filter pump is arranged at the bottom of the filter tank, and the filter core groove is arranged above the filter pump.

As a further improvement of the foregoing technical solution, the climbing platform holder is a side wall of the filter tank, and a vertical runner is arranged in the climbing platform holder; the oblique climbing platform is provided with a fixed clamping block, the fixed clamping block is arranged in the upper water surface end, the fixed clamping block is arranged in the vertical runner, and the fixed clamping block is provided with a clamping bolt for fixing a position of the fixed clamping block.

As a further improvement of the foregoing technical solution, the filter tank is an enclosed structure, and the filter pump includes a pump inlet and a pump outlet, the pump outlet is located outside the filter tank, the pump inlet is located inside the filter tank, the filter tank is provided with a purified water outlet, and the purified water outlet is arranged in a top portion of two side walls on the filter tank and adjacent to the climbing platform holder.

As a further improvement of the foregoing technical solution, the filter core groove includes two core groove housings which are mutually buckled, the core groove housing is provided with a plurality of hollow filter through holes, and the inside of the core groove housing is provided with filter cotton for filtering impurities in water and activated carbon for absorbing and purifying water quality.

As a further improvement of the foregoing technical solution, the top of the filter tank is provided with a lighting lamp.

As a further improvement of the foregoing technical solution, the lighting lamp is a sunlight analog lamp.

Compared with the prior art, the present invention has the advantageous effects as follows:

According to the amphibian environment filtration and purification climbing platform provided by the present invention, the amphibious climbing platform system is combined with the cyclic purification system, so that ecological breeding environments of amphibians and reptiles are improved, methods of breeding the amphibians are optimized, life habit features of the amphibians can be preferably satisfied, health conditions of the amphibians and reptiles bred are increased, and facility product categories for breeding amphibians are richened; in thus way, the amphibian environment filtration and purification climbing platform is beneficial for further generalizing the breeding of the amphibians and reptiles.

### BRIEF DESCRIPTION OF THE DRAWINGS

The present invention will be further described hereinafter with reference to the drawings and embodiments.

FIG. 1 is a structural schematic diagram of an amphibian environment filtration and purification climbing platform, according to the present invention;

FIG. 2 is a structural schematic diagram of a cyclic purification system after a filter tank is removed, according to the present invention;

FIG. 3 is a structural schematic diagram of a core groove housing, according to the present invention; and FIG. 4 is a schematic diagram of a bottom structure of a cyclic purification system, according to the present invention.

### DETAILED DESCRIPTION

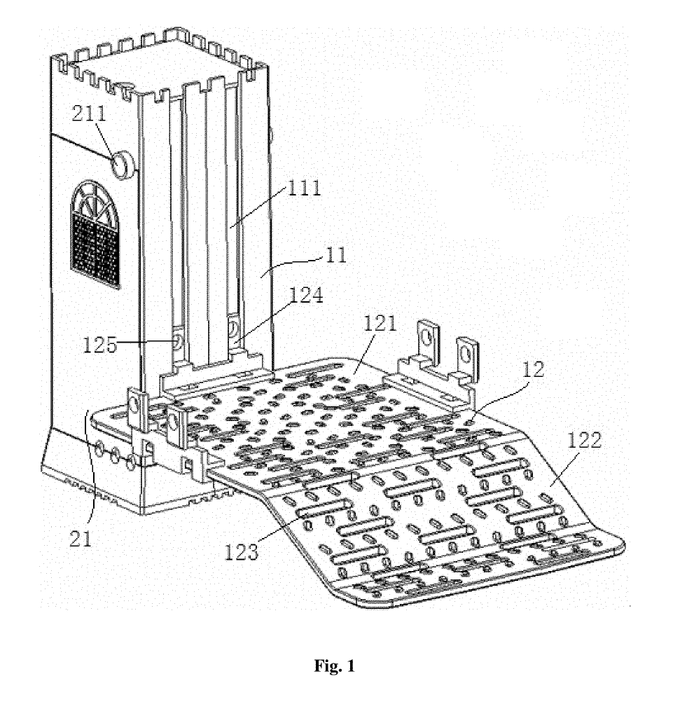

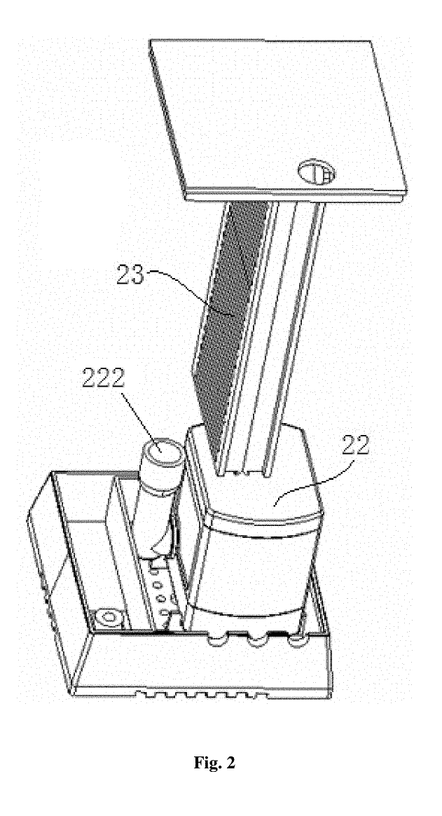

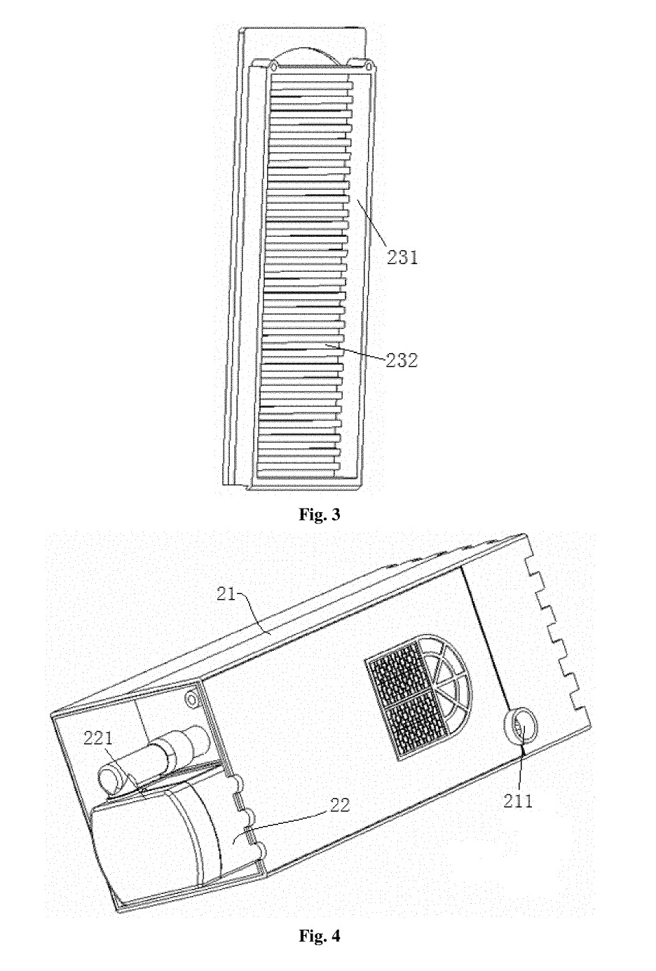

Please refer to FIG. 1 to FIG. 4. FIG. 1 to FIG. 4 are structural schematic diagrams of one specific embodiment of the present invention.

As shown in FIG. 1 to FIG. 4, an amphibian environment filtration and purification climbing platform includes an amphibious climbing platform system. The amphibious climbing platform system includes a climbing platform holder 11 and an oblique climbing platform 12, the oblique climbing platform 12 includes an upper water surface end and a lower water surface end, and the upper water surface end is fixedly connected with the climbing platform holder. The oblique climbing platform 12 includes a horizontal dwelling segment 121 which is horizontally arranged for amphibians to dwell on and an oblique crawling segment 122 which is obliquely arranged for the amphibians to crawl to the horizontal dwelling segment 121 from water; moreover, the horizontal dwelling segment 121 is located at the upper water surface end, and the oblique crawling segment 122 is located at the lower water surface end. A plurality of hollow drain holes 123 are arranged in the oblique climbing platform 12.

A cyclic purification system is further included, wherein the cyclic purification system includes a filter tank 21, a filter pump 22 and a filter core groove 23 arranged in the filter tank 21; the filter pump 22 is arranged at the bottom of the filter tank 21, and the filter core groove 23 is arranged above the filter pump 22. The climbing platform holder 11 is a side wall of the filter tank 21, and a vertical runner 111 is arranged in the climbing platform holder 11, the oblique climbing platform 12 is provided with a fixed clamping block 124, the fixed clamping block 124 is arranged in the upper water surface end, the fixed clamping block 124 is arranged in the vertical runner 111, and the fixed clamping block 124 is provided with a clamping bolt for fixing a position of the fixed clamping block 124. The filter tank 21 is an enclosed structure, and the filter pump 22 includes a pump inlet 221 and a pump outlet 222, the pump outlet 222 is located outside the filter tank 21, the pump inlet 221 is located inside the filter tank 21, the filter tank 21 is provided with a purified water outlet 211, and the purified water outlet 211 is arranged in a top portion of two side walls on the filter tank 21 and adjacent to the climbing platform holder 11.

Further, the filter core groove 23 includes two core groove housings 231 which are mutually buckled, the core groove housing 231 is provided with a plurality of hollow filter through holes 232, and the inside of the core groove housing 231 is provided with filter cotton for filtering impurities in water and activated carbon for absorbing and purifying water quality. The top of the filter tank 21 is provided with a lighting lamp. Preferably, the lighting lamp is a sunlight analog lamp.

An integrated castle structure may also be adopted to the filter tank 21, which is not only compact in structure, but also is beneficial for improving the entire beauty of the breeding environment. To be specific, the filter tank 21 can be a plastic product; and the side or bottom of the filter tank 21 may be fixed to the bottom or wall of a breeding tank through a sucker or hook. The filter pump 22 is arranged inside the bottom of the filter tank 21, breeding water is led to the inside of the filter tank 23 through the filter pump 22, and impurities in the breeding water are filtered and purified clearly by the filter core groove 23, so that an environment purification effect is achieved.

The height of the upper water surface end of the oblique climbing platform can be adjusted freely, so as to adapt to different water surface heights. The clamping bolt is not shown in FIG. 1, but a clamping screw 125 for installing the clamping bolt can be referred to, so that an installation manner of the clamping bolt can be known apparently. The foregoing structure enables long-term diving amphibians and reptiles to crawl to the horizontal dwelling segment 121 through the oblique climbing platform 122 of the oblique climbing platform 12, thus being beneficial for the amphibians and reptiles to have a rest, enjoy the sunshine, and absorb the effects of the sunshine. The climbing platform is beneficial for the growing of the amphibians and reptiles and complies with the ecologic features of the amphibians since the climbing platform provides a dry and salubrious resting environment.

When the present invention is disposed indoors for use, the lighting lamp is arranged at the top of the filter tank 21, which can not only play a role of lighting to facilitate viewing and beautifying; moreover, lights with different wave bands can be configured according to different species bred to simulate the irradiation of sunshine, so that the oblique climbing platform 12 can also be used as a sunbathing platform, which sufficiently reflects the ecological properties of the amphibian environment filtration and purification climbing platform according to the present invention.

The preferred embodiments of the invention have been described in details above. Of course, forms different from the foregoing embodiments may also be adopted in the invention, and any equivalent transformation or corresponding alternation made by those skilled in the art without departing from the spirit of the invention shall all fall within the protection scope of the invention.

What is claimed is:

1. An amphibian environment filtration and purification climbing platform, comprising an amphibious climbing platform system, wherein the amphibious climbing platform system comprises a climbing platform holder and an oblique climbing platform, the oblique climbing platform comprises an upper water surface end and a lower water surface end, and the upper water surface end is fixedly connected with the climbing platform holder.

2. The amphibian environment filtration and purification climbing platform according to claim 1, wherein the oblique climbing platform comprises a horizontal dwelling segment which is horizontally arranged for amphibians to dwell on and an oblique crawling segment which is obliquely arranged for the amphibians to crawl to the horizontal dwelling segment from water; and the horizontal dwelling segment is located at the upper water surface end, and the oblique crawling segment is located at the lower water surface end.

3. The amphibian environment filtration and purification climbing platform according to claim 1, wherein a plurality of hollow drain holes are arranged in the oblique climbing platform.

4. The amphibian environment filtration and purification climbing platform according to claim 1, further comprising a cyclic purification system, wherein the cyclic purification system comprises a filter tank, a filter pump and a filter core groove arranged in the filter tank, the filter pump is arranged at the bottom of the filter tank, and the filter core groove is arranged above the filter pump.

5. The amphibian environment filtration and purification climbing platform according to claim 4, wherein the climbing platform holder is a side wall of the filter tank, and a vertical runner is arranged in the climbing platform holder, the oblique climbing platform is provided with a fixed clamping block, the fixed clamping block is arranged in the upper water surface end, the fixed clamping block is arranged in the vertical runner, and the fixed clamping block is provided with a clamping bolt for fixing a position of the fixed clamping block.

6. The amphibian environment filtration and purification climbing platform according to claim 5, wherein the filter tank is an enclosed structure, and the filter pump comprises a pump inlet and a pump outlet, the pump outlet is located outside the filter tank, the pump inlet is located inside the filter tank, the filter tank is provided with a purified water outlet, and the purified water outlet is arranged in a top portion of two side walls on the filter tank and adjacent to the climbing platform holder.

7. The amphibian environment filtration and purification climbing platform according to claim 4, wherein the filter core groove comprises two core groove housings which are mutually buckled, the core groove housing is provided with a plurality of hollow filter through holes, and the inside of the core groove housing is provided with filter cotton for filtering impurities in water and activated carbon for absorbing and purifying water quality.

8. The amphibian environment filtration and purification climbing platform according to claim 4, wherein the top of the filter tank is provided with a lighting lamp.

9. The amphibian environment filtration and purification climbing platform according to claim 8, wherein the lighting lamp is a sunlight analog lamp.
